(19) United States
(12) Patent Application Publication
(10) Pub. No.: US 2022/0055060 A1
(43) Pub. Date: Feb. 24, 2022

(54) HIGH-PRESSURE VALVE FOR AN ATOMIZING NOZZLE, AND METHOD FOR RINSING A HIGH-PRESSURE VALVE

(71) Applicant: LUEBBERS ANLAGEN- UND UMWELTTECHNIK GMBH, BAD LANGENSALZA (DE)

(72) Inventor: MATTHIAS LUEBBERS, BAD LANGENSALZA (DE)

(73) Assignee: LUEBBERS ANLAGEN- UND UMWELTTECHNIK GMBH, BAD LANGENSALZA (DE)

(21) Appl. No.: 17/311,351

(22) PCT Filed: Nov. 19, 2019
(86) PCT No.: PCT/DE2019/200134

§ 371 Date: Oct. 25, 2021

(30) Foreign Application Priority Data
Dec. 10, 2018 (DE) 102018131496.5

(51) Int. Cl. B05B 15/55; B05B 1/08; B05B 1/30; B05B 15/52

(52) U.S. Cl. CPC B05B 15/55; B05B 15/52; B05B 1/3026; B05B 1/083

(57) ABSTRACT

A high-pressure valve for a spray nozzle. The high-pressure valve includes a valve inlet, a valve outlet to which the spray nozzle is attachable, a fluid connection which connects the valve inlet to the valve outlet, a movable piston, a tappet which is arranged in the fluid connection, and a flushing apparatus which flushes the high-pressure valve and/or the spray nozzle with a flushing liquid. The tappet moves between a closed position and an open position via the movable piston. A spray liquid reaches the valve outlet and/or the spray nozzle from the valve inlet via the fluid connection when the tappet is in the open position.

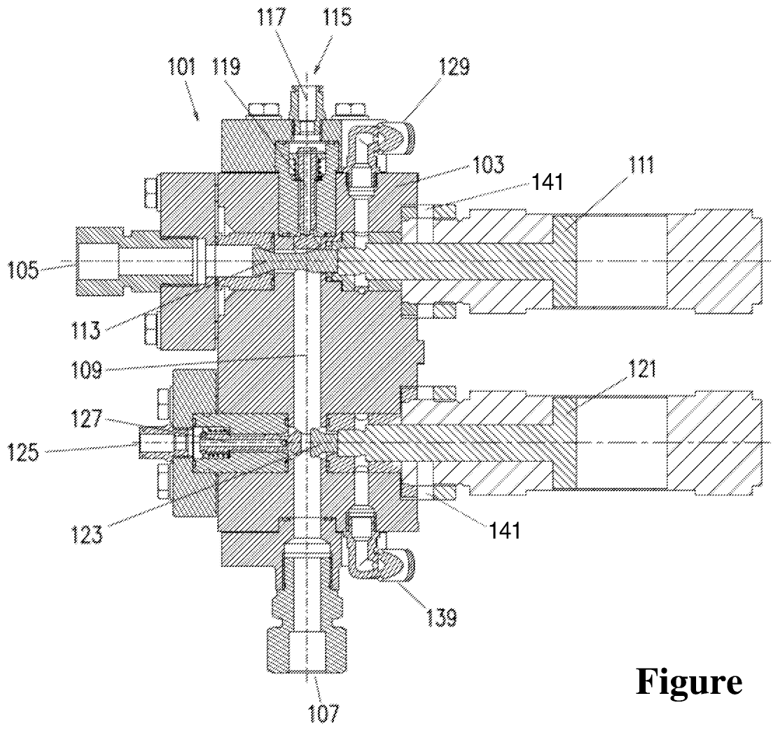

### CROSS REFERENCE TO PRIOR APPLICATIONS

This application is a U.S. National Phase application under 35 U.S.C. § 371 of International Application No. PCT/DE2019/200134, filed on Nov. 19, 2019 and which claims benefit to German Patent Application No. 10 2018 131 496.5, filed on Dec. 10, 2018. The International Application was published in German on Jun. 18, 2020 as WO 2020/119867 A1 under PCT Article 21(2).

### FIELD

The present invention relates to a high-pressure valve for a spray nozzle, wherein the high-pressure valve comprises a valve inlet, a valve outlet, a fluid connection, at least one first movable piston, and a tappet, the valve inlet being connected to the valve outlet via the fluid connection, the tappet being arranged in the fluid connection, and the spray nozzle being attachable to the valve outlet, wherein the tappet is movable between a closed position and an open position via the first movable piston and, in case of the open position of the tappet, a spray liquid reaches the valve outlet and/or the spray nozzle from the valve inlet through the fluid connection. The present invention also relates to a method for subsequently cleaning a high-pressure valve.

### BACKGROUND

High-pressure valves are used as components for shutting off and controlling a flow of a liquid or gas in a wide range of applications. A high-pressure valve is, for example, arranged upstream of a spray nozzle in a spray tower in which a substance to be dried is being sprayed. A spray tower usually uses a plurality of spray nozzles in parallel, which are each switched on and/or off via a high-pressure valve depending on process fluctuations. After switching off the high-pressure valve, it is undesirable for the substance to be dried or its constituents to be deposited and/or start to dry either in the high-pressure valve itself or in the attached spray nozzle, since this is a potential hotspot which presents an increased risk of fire and explosion. Due to the deposited and/or drying residues, there is also the risk of increased wear of the high-pressure valve and/or the attached spray nozzle (high-pressure nozzle), in particular due to a prevailing pressure of greater than 10 MPa, and that its/their functionality may be impaired. Remaining residues must also be removed from the high-pressure valve and/or high-pressure nozzle when a new batch is used and/or when the product is changed during spraying.

For the above reasons, a high-pressure valve and/or high-pressure nozzle must be cleaned after being switched off and/or being used. To accomplish this, the high-pressure valve and/or high-pressure nozzle must first be disassembled and removed from the installation. The high-pressure valve and/or high-pressure nozzle itself are then taken apart and all the (valve) parts that come into contact with the spray liquid must be cleaned, inspected, and/or reconditioned where necessary. During the subsequent complex reassembly of the high-pressure valve and/or high-pressure nozzle, maintenance work, such as introducing new sealing material and/or new lubrication, must also be performed.

The required disassembly, cleaning, and reassembly of the high-pressure valve and/or high-pressure nozzle by one person is therefore very complex and expensive. A high-pressure valve and/or high-pressure nozzle requiring cleaning cannot therefore be reintegrated into the production process shortly thereafter.

Even if a high-pressure valve and/or high-pressure nozzle is flushed with air after being switched off, residues and droplets which cause the above-mentioned problems still remain in the high-pressure valve and/or high-pressure nozzle due to the viscosity of the product to be sprayed.

DE 103 38 064 A1 describes a method for flushing a paint valve in a painting system and the feed line from a paint-conducting line to the paint valve. The feed line to the paint valve must here be depressurized and the output of the paint-change block must also be blocked in order to feed pulsed air and thinner to the open paint valve for cleaning at a low pressure of less than 1 MPa and to conduct the pulsed air and thinner away backwards through the feed line.

DE 199 51 956 A1 describes a method for flushing a paint-change valve assembly in which, before a paint change, a flushing agent and compressed air are alternately conducted through the central paint channel at a pressure of less than 1 MPa. The individual paint valves of the paint-change valve assembly are not flushed.

### SUMMARY

An aspect of the present invention is to improve upon the prior art.

In an embodiment, the present invention provides a high-pressure valve for a spray nozzle. The high-pressure valve includes a valve inlet, a valve outlet which is configured to have the spray nozzle be attachable thereto, a fluid connection which connects the valve inlet to the valve outlet, at least one first movable piston, a tappet which is arranged in the fluid connection, and a flushing apparatus which is configured to flush at least one of the high-pressure valve and the spray nozzle with a flushing liquid. The tappet is configured to move between a closed position and an open position via the at least one first movable piston. A spray liquid reaches at least one of the valve outlet and the spray nozzle from the valve inlet via the fluid connection when the tappet is in the open position.

### BRIEF DESCRIPTION OF THE DRAWING

The present invention is described in greater detail below on the basis of embodiments and of the drawing in which:

The FIGURE shows a schematic sectional view of a high-pressure valve comprising a flushing apparatus which uses water.

### DETAILED DESCRIPTION

The present invention provides a high-pressure valve for an spray nozzle, wherein the high-pressure valve comprises a valve inlet, a valve outlet, a fluid connection, at least one first movable piston, and a tappet, the valve inlet being connected to the valve outlet via the fluid connection, the tappet being arranged in the fluid connection, and the spray nozzle being attachable to the valve outlet, wherein the tappet is movable between a closed position and an open position via the first movable piston and, in case of the open position of the tappet, a spray liquid reaches the valve outlet and/or the spray nozzle from the valve inlet through the fluid connection, wherein the high-pressure valve comprises a flushing apparatus for flushing the high-pressure valve and/or the spray nozzle with a flushing liquid.

A high-pressure valve and/or an attached spray nozzle can therefore be flushed via the flushing apparatus immediately after being switched off and/or used without the high-pressure valve and/or the spray nozzle being disassembled from the process system and without it being necessary to manually dismantle, clean, and reassemble the high-pressure valve and/or the spray nozzle.

It is particularly advantageous for flushing and thus cleaning of the high-pressure valve and/or spray nozzle to be carried out automatically immediately after the valve is switched off, so that a time-consuming and resource-intensive manual disassembly and cleaning of the high-pressure valve and/or spray nozzle can be avoided. Depending on the production process and/or the status of the system, a single high-pressure valve and/or the spray nozzle is as a result rapidly switched off and, after it is flushed, is quickly put back into operation and re-joins the process. In the event of a process disruption, the high-pressure valve and/or the spray nozzle and thus the entire system is therefore more rapidly made available for operation.

Since the flushing apparatus is integrated within the high-pressure valve, the high-pressure valve and/or the spray nozzle can be flushed immediately after operation, so that the residues of the spray liquid are only deposited within the high-pressure valve and/or the attached spray nozzle for a very short period of time. Stubborn residues are prevented from adhering and the cleaning quality is improved via the prompt flushing. The quality of the product to be dried is therefore prevented from being impaired by residues in the high-pressure valve and/or the spray nozzle and when product batches are changed.

The formation of undesired potential hotspots and the risk of fire and explosion are also reduced.

An important concept of the present invention is based on the fact that the components of the high-pressure valve and/or the attached spray nozzle filled with spray liquid are promptly and immediately flushed with a flushing liquid without disassembling the high-pressure valve and/or the spray nozzle, thereby preventing a disruption due to remaining residues of the spray liquid and providing an automatic, rapid cleaning, and thus a rapid re-entry into operation due to the direct integration of the flushing apparatus in the high-pressure valve.

The following terms are explained:

A “high-pressure valve” is in particular a component for shutting off and/or controlling a flow of a fluid (liquid and/or gas). During operation, a high-pressure valve in particular has a pressure of greater than 10 MPa to 100 MPa. A high-pressure valve is in particular made of stainless steel, for example, having the material number 1.4439, 1.4571 and/or 1.4404, and is accordingly pressure-resistant, wear-resistant and/or abrasion-resistant.

A “spray nozzle” (also called an “atomizer nozzle” or a “high-pressure nozzle”) is in particular a nozzle for spraying a liquid substance to be dried in fine droplets and for simultaneously distributing the fine droplets in a drying gas. The spraying nozzle is in particular used to generate a very large reactive surface area of the spray liquid by spraying. A spray nozzle is in particular a single-substance nozzle, a dual-substance nozzle, a three-substance nozzle, a four-substance nozzle, and/or an ultrasonic nozzle, and/or the spray nozzle is integrated in a rotation sprayer. The spray nozzle in particular has an opening of from 0.1 to 5 mm, for example, of from 0.5 to 3 mm.

A “spray liquid” is in particular a liquid, such as a solution, suspension or emulsion, which is conveyed through the high-pressure valve and/or is sprayed by the spray nozzle for drying and forming dry particles (individual particles, agglomerates and/or granulates).

A “valve inlet” is in particular referred to as a part of the high-pressure valve through which the spray liquid enters the interior of the high-pressure valve. A valve inlet may, for example, be a male connector in the valve body to which a pipeline is connected which continuously supplies the spray liquid to the high-pressure valve.

A “valve outlet” is in particular part of the high-pressure valve through which the spray liquid and/or a flushing liquid again leaves the high-pressure valve. The valve outlet may, for example, likewise be a male connector on which a spray nozzle may be arranged either directly or with a pipe connection therebetween.

A “fluid connection” is in particular part of the high-pressure valve which makes it possible for the spray liquid to flow from the valve inlet to the valve outlet. The fluid connection may, for example, be a pipeline within the high-pressure valve or a recess in the valve body of the high-pressure valve. The fluid connection is in particular used to transport a fluid or a plurality of fluids (gas and/or liquid) within the high-pressure valve.

A “piston” is in particular referred to as a movable component of the high-pressure valve which forms, together with its surrounding housing, a closed cavity of which the volume changes due to movement of the piston. A piston may, for example, be a round disc which enters a tubular cylinder in the form of a housing or a recess in the valve body. The relevant position of the piston in the housing here determines the volume of the cavity.

“Movable” means that the position of the piston in the housing can be changed. The piston may, for example, be moved pneumatically by compressed air acting on the rear face of the piston.

A “tappet” is in particular a specially formed rod which constitutes the closure part of the high-pressure valve. The tappet is in particular arranged in the fluid connection and can be moved by the first movable piston between a closed position, in which a fluid cannot pass through the fluid connection, and an open position, in which the fluid can pass around the tappet in the fluid connection.

In a “closed position” of the tappet, the specially formed tappet is moved and thus brought into a position by the movable piston so that a sealing surface of the tappet is pressed against a sealing seat and thus blocks the fluid connection.

In an “open position” of the tappet, the first movable piston brings the specially formed tappet into a position in which a fluid can flow through the fluid connection around the tappet. In an open position, the spray liquid therefore reaches the valve outlet and/or the subsequently attached spray nozzle from the valve inlet through the fluid connection, by passing the tappet.

A “flushing apparatus” (also called a “post flushing apparatus”) is in particular an apparatus of the high-pressure valve which, after spray liquid flows through the fluid connection, is used to flush the high-pressure valve and/or the spray nozzle with a flushing liquid. All the parts of the high-pressure valve which have been wetted as the spray liquid passes therethrough are in particular flushed and thus cleaned by the flushing apparatus. A flushing apparatus may, for example, be a liquid container within the high-pressure valve and/or may be a connection part for externally supplying flushing liquid.

A “flushing liquid” is in particular a liquid via which the high-pressure valve and in particular its parts to which spray liquid is supplied are flushed. A flushing liquid may in particular be water or ultrapure water. A flushing liquid is in particular free of particles and/or other particulate constituents. To improve the cleaning, the flushing liquid may comprise a chemical substance, for example, sodium hydroxide or nitric acid. A flushing liquid may be what is known as a CIP solution (clean-in-place solution), which is in particular specially adapted to the process in question and makes cleaning possible on the surfaces contacted by the spray liquid without disassembling the high-pressure valve. The composition of the flushing liquid, the pressure or pressure profile used, and/or the temperature or temperature profile used, as well as the flushing time, are in particular set in a reproducible manner to accomplish this.

In another embodiment of the high-pressure valve, the flushing apparatus comprises a flushing-liquid inlet and/or a non-return valve.

After operation of the high-pressure valve, a flushing liquid can therefore be immediately supplied continuously or discontinuously via the flushing-liquid inlet.

The “flushing-liquid inlet” may, for example, be a connector at which a pipeline and a high-pressure pump for supplying the flushing liquid are arranged.

The flushing-liquid inlet can, for example, have a direct and very short connection to the fluid connection so that a rapid flushing is possible without large clearance volumes.

A “non-return valve” is in particular a component which allows a fluid (liquid, gas) to flow in just one direction. The spray liquid is thus prevented from flowing into the flushing apparatus.

To provide an optimal flushing of the fluid connection, the flushing apparatus is arranged at the fluid connection so that the flushing liquid acts on the tappet perpendicularly to a longitudinal orientation of the tappet.

The flushing apparatus is as a result arranged directly at the fluid connection with a very short path and so that the fluid connection as well as the tappet are flushed at the same time in different positions.

It is particularly advantageous that the flushing liquid supplied by the flushing apparatus flows directly along the fluid connection or the majority of the fluid connection and acts perpendicularly on the movable tappet in the process. By moving the tappet into different positions between the closed position and the open position, the flushing liquid can be pulsed around the tappet and in the fluid connection so as to thereby improve the post flushing and/or cleaning.

The “longitudinal orientation” is in particular the orientation of the tappet in which the tappet has its greatest length. The longitudinal orientation of the tappet is thus in particular the direction of its greatest extension. The longitudinal orientation of the tappet in particular coincides with the direction in which or counter to which the tappet is moved owing to the movement of the first movable piston.

In another embodiment, the high-pressure valve is configured so that the high-pressure valve is designed for a pressure in a range of from 10 MPa to 50 MPa, for example, of from 15 MPa to 35 MPa. The high-pressure valve may of course also be designed for higher pressures of over 100 MPa.

“Pressure” is here in particular understood to be the fluid pressure, i.e., the pressure due to the spray liquid, flushing liquid, and/or a gas on a surface within the high-pressure valve.

To mix gas into the spray liquid and/or to allow a gas-pulsing operation of the high-pressure valve, the high-pressure valve comprises a ventilation tappet and a second movable piston, wherein the ventilation tappet is arranged in the fluid connection and is movable by the second movable piston.

A “ventilation tappet” corresponds to the above-defined tappet in terms of its configuration and movability. The spray liquid or the flushing liquid in the fluid connection and a gas can, however, flow around a ventilation tappet at the same time or in succession.

The “second movable piston” corresponds to the above-defined movable piston, however, the second movable piston is assigned to the ventilation tappet.

In another embodiment of the high-pressure valve, the first movable piston and/or the second movable piston are each designed as a double-acting piston.

Via the design as a double-acting piston, the first movable piston and/or the second movable piston each have twice the piston area, which means that each of the pistons themselves and thus the high-pressure valve are smaller in size.

A “double-acting piston” (also called a “tandem cylinder”) is in particular a piston which comprises two cylinders or piston discs, which are interconnected and arranged in succession. A greater force is achieved via a double-acting piston despite a smaller size, in particular owing to an increase in the effective piston area.

The ventilation tappet is connected to a pressure outlet in order to release residual pressure caused by spray liquid, flushing liquid, and/or gas in the high-pressure valve after using the high-pressure valve.

The second movable piston can therefore bring the ventilation tappet into such a position that the pressure outlet is opened and a fluid having a residual pressure can leave the high-pressure valve. The safety of the high-pressure valve is thereby increased.

A “pressure outlet” is in particular a part of the high-pressure valve through which a fluid located in the fluid connection can escape from the interior of the high-pressure valve, meaning that, in particular, the residual pressure in the high-pressure valve drops to the ambient atmospheric pressure.

In another configuration of the high-pressure valve, the ventilation tappet is connected to a gas inlet and/or a non-return valve.

The subsequent spraying process can therefore, for example, be influenced by an attached spray nozzle by a gas being mixed into the spray liquid in the fluid connection via the ventilation tappet.

It is particularly advantageous for a gas to be supplied into the interior of the high-pressure valve and/or the fluid connection via the gas inlet so that, after flushing the high-pressure valve, any droplets of liquid that may be present are expelled from the high-pressure valve and the flushed parts of the high-pressure valve are dried by the gas. This can provide that a high-viscosity substance to be dried or the flushing liquid do not remain in the interior of the high-pressure valve, and that deposits do not solidify.

A “gas inlet” is in particular a part of the high-pressure valve through which a gas enters the interior of the high-pressure valve and/or reaches the ventilation tappet and the fluid connection. A gas inlet may, for example, be a push-in screwed connection.

It is particularly advantageous for the ventilation tappet to be formed so that it has an open position and a closed position with regard to the flow of a gas and of a liquid through the fluid connection, with it being possible for all the combinations of the respective open and closed positions to be set.

The ventilation tappet is arranged in the fluid connection in a flow direction of the spray liquid behind the tappet in order to provide an optimal interaction of the tappet and the ventilation tappet.

As a result, in the open position of the tappet, the spray liquid first flows past the tappet in the fluid connection and then flows to the ventilation tappet. It is here particularly advantageous for the form of the ventilation tappet to be such that the spray liquid can flow past the ventilation tappet even in the closed position of the ventilation tappet with regard to a gas so that all possible switching and/or position combinations of the ventilation tappet and the tappet can be produced.

The “flow direction” is in particular the direction in which the spray liquid moves from the valve inlet to the valve outlet or the direction in which the flushing liquid moves from the flushing apparatus and/or the flushing-liquid inlet to the valve outlet.

In another embodiment, the high-pressure valve comprises an inductive sensor or a plurality of inductive sensors, so that a position of the first movable piston, the second movable piston, the tappet, and/or the ventilation tappet can be determined.

The position of the first and/or second movable piston, the tappet, and/or the ventilation tappet can therefore not only be predetermined, but can also be metrologically determined by an inductive sensor or a plurality of inductive sensors and can thus be checked and/or regulated. The inductive sensor or inductive sensors can also be connected to a control and/or regulating apparatus of the process system and can be used to actuate and/or regulate the high-pressure valve.

The operational safety of the high-pressure valve is therefore increased.

An “inductive sensor” in particular measures the change in inductance or its quality due to a change in position relative to a conductive and/or ferromagnetic part of the sensor. In the process, the inductive sensor operates with an inductance (open coil) which generates a magnetic field, with this being changed by an object, for example, the movable piston. An angle, path, distance, and/or speed can as a result be measured contactlessly and without wear.

The present invention also provides a method for subsequently cleaning a high-pressure valve, wherein the high-pressure valve is a high-pressure valve as described above, the method comprising the following steps:
terminating an external supply of spray liquid to the valve inlet of the high-pressure valve;
moving the tappet into the closed position via the first movable piston of the high-pressure valve so that the valve inlet is closed and the flushing-liquid inlet is open;
relieving the pressure on the high-pressure valve by opening the ventilation tappet via the second movable piston and dissipating the pressure via the pressure outlet;
supplying flushing liquid through the flushing-liquid inlet and/or via the non-return valve into the fluid connection of the high-pressure valve so that the pressure outlet is flushed,
closing the ventilation tappet via the second movable piston of the high-pressure valve and therefore closing the pressure outlet; and
supplying more flushing liquid so that the fluid connection, the tappet, the ventilation tappet, and/or the spray nozzle are flushed by the flushing liquid.

A method for post flushing and subsequently cleaning a high-pressure valve is thus provided which can be carried out immediately after a regular operation of the high-pressure valve without the high-pressure valve first having to be disassembled. The method can in particular be carried out in an automated manner for the subsequent cleaning, for example, via a system control and/or regulating apparatus.

After disruption to the high-pressure valve and/or after the high-pressure valve has been switched off, an attached spray nozzle can also be promptly put back into operation and incorporated back into the overall process after the high-pressure valve and/or the spray nozzle is briefly subsequently cleaned.

In another configuration of the method, water having a pressure in a range of from 5 MPa to 25 MPa, for example, of from 10 MPa to 20 MPa, is used as the flushing liquid.

The high-pressure valve and/or the spray nozzle is dried after the subsequent cleaning by introducing a gas through the gas inlet and/or the gas-side non-return valve in order to prevent residues of the spray liquid and/or the flushing liquid and to ensure the product quality during spraying.

The liquid remaining on the liquid-wetted parts of the high-pressure valve and/or the spray nozzle is as a result not only expelled, but is also dried. In subsequent operation, no mixing of new spray liquid and flushing liquid and/or old spray liquid therefore takes place.

“Drying” is in particular understood to mean removing liquid from the high-pressure valve and/or the spray nozzle. In particular the liquid-wetted inner parts of the high-pressure valve and/or the spray nozzle are dried via the drying, with the liquid being thermally and/or physically converted into the gaseous state.

A “gas” is in particular air, an inert gas, and/or a shielding gas, such as nitrogen, or argon. The gas may in particular have an ambient temperature or a temperature higher than ambient temperature. The gas is in particular free of particles.

The present invention will be explained in greater detail below on the basis of an embodiment as shown in the drawing.

A high-pressure valve 101 comprises a valve body 103 made of chromium-nickel-molybdenum steel (material number 1.4404). A liquid inlet 105 and a liquid outlet 107 are screwed into the valve body 103. The liquid inlet 105 is connected to the liquid outlet 107 via a connection line 109.

The high-pressure valve 101 further comprises a tappet 113 and a ventilation tappet 123, which are each arranged in their longitudinal orientation perpendicular to a flow direction in the connection line 109 leading downwards to the liquid outlet 107. The tappet 113 and the ventilation tappet 123 each have a special form.

The high-pressure valve 101 has two connections (which are not shown in the drawing) for supplying compressed air. The upper connection (which is not shown in the drawing) for compressed air is operatively connected to the tappet 113 via a first double-acting piston 111 and an upper compression spring (which is not shown in the drawing), while the lower connection (which is not shown in the drawing) for compressed air is operatively connected to the ventilation tappet 123 via a second double-acting piston 121 and a lower compression spring (which is not shown in the drawing).

The ventilation tappet 123 is connected to an air inlet 125 and a gas inlet non-return valve 127 on the side of the ventilation tappet 123 opposite the second double-acting piston 121. The ventilation tappet 123 is also connected to a pressure outlet 139. The tappet 113 is likewise connected to a pressure outlet 129.

To metrologically determine a position of the tappet 113, the first double-acting piston 111, the ventilation tappet 123, the second double-acting piston 121, and the high-pressure valve 101 comprise accordingly arranged inductive sensors 141.

A flushing apparatus 115 is arranged above the tappet 113 on the connection line 109. The flushing apparatus 115 comprises a flushing liquid inlet 117 and a flushing apparatus non-return valve 119.

A spray nozzle (which is not shown in the drawing) of a spray dryer (which is not shown in the drawing) is arranged on the liquid outlet 107, with pre-thickened milk being sprayed in the spray dryer. Pre-thickened milk is thereby supplied to the liquid inlet 105 of the high-pressure valve 101 at a pressure of 30 MPa via a high-pressure pump (which is not shown in the drawing), this milk flowing around the tappet 113 and the ventilation tappet 123 through the connection line 109 in the open position of the tappet 113 and continuously reaching the liquid outlet 107 and thus the spray nozzle (which is not shown on the drawing).

The spray nozzle (which is not shown in the drawing) must be disconnected due to a process fluctuation. The following processes are thereafter implemented using the high-pressure valve 101:

The high-pressure pump (which is not shown in the drawing) for externally supplying pre-thickened milk to the liquid inlet 105 of the high-pressure valve 101 is stopped and the tappet 113 is brought into a closed position with regard to the flow of the pre-thickened milk by supplying compressed air at the upper connection (which is not shown in the drawing) of the first double-acting piston 111 and at the upper compression spring (which is not shown in the drawing), so that the pre-thickened milk can no longer pass through the liquid inlet 105.

The pressure on the high-pressure valve 101 is then relieved by opening the ventilation tappet 123, the ventilation tappet 123 being moved into the corresponding open position via compressed air at the lower connection (which is not shown in the drawing) of the second double-acting piston 121 and the lower compression spring (which is not shown in the drawing), and the thickened milk remaining in the connection line 109 below the tappet 113 is drained from the high-pressure valve 101 via the pressure outlet 139 and thus pressure is relieved.

As a next step, CIP solution, which contains water and 3 wt. % sodium hydroxide, is fed through the flushing liquid inlet 117 and a water cartridge of the flushing apparatus 115, around the tappet 113 of the connection line 109, via a flushing pump (which is not shown in the drawing) at a pressure of 15 MPa. A corresponding portion of the connection line 109 and the pressure outlet 139 is thereby first flushed.

The ventilation tappet 123 is then closed by the second double-acting piston 121 so that the pressure outlet 139 is closed. As a result, the connection line 109, the liquid outlet 107, and the attached spray nozzle (which is not shown in the drawing) is then flushed and cleaned. As the CIP solution passes through the connection line 109, the ventilation tappet 123 is easily moved back and forth around its open position via the second double-acting piston 121, so that the CIP solution is pulsed in the connection line 109 and, as a result, the cleaning performance is improved and cleaning of the ventilation tappet 123 itself is achieved.

In this flushing process with a duration of 30 seconds, the pressure outlet 139, the tappet 113, the connection line 109, the ventilation tappet 123, and the spray nozzle (which is not shown in the drawing) are thus flushed and cleaned.

The ventilation tappet 123 is then brought into its open position for air via the second double-acting piston 121, so that particle-free air at a pressure of 0.6 MPa and a temperature of 40° C. flows through the air inlet 125 and via the gas inlet non-return valve 127 around the ventilation tappet 123 and therefore flows into the connection line 109 and through the liquid outlet 107 to the spray nozzle (which is not shown in the drawing). There is thus particle-free, dried air in the connection line 109, which absorbs and dries the moisture of the connection line 109 wetted with CIP solution, the tappet 113, the ventilation tappet 123, and the liquid outlet 107, as well as the spray nozzle (which is not shown in the drawing) that is attached thereto.

After the integrated CIP flushing of the high-pressure valve 101 via the flushing apparatus 115 and via the subsequent drying within 3 minutes, the high-pressure valve 101 can therefore re-enter operation without remaining residues causing a process disruption.

In an alternative, the high-pressure valve 101 is operated during the flushing so that first the pressure outlet 129 of the tappet 113 is flushed, then the pressure outlet 139 of the ventilation tappet 123 is flushed, and subsequently the entire connection line 109 is flushed using the attached spray nozzle (which is not shown in the drawing). A step-by-step, multi-stage flushing of the high-pressure valve 101 is thus implemented and recontamination during the flushing is prevented.

The present invention is not limited to embodiments described herein; reference should be had to the appended claims.

### LIST OF REFERENCE NUMERALS

101 High-pressure valve
103 Valve body
105 Liquid inlet
107 Liquid outlet
109 Connection line
111 First double-acting piston
113 Tappet
115 Flushing apparatus
117 Flushing liquid inlet
119 Flushing apparatus non-return valve
121 Second double-acting piston
123 Ventilation tappet
125 Air inlet
127 Gas inlet non-return valve
129 Pressure outlet
139 Pressure outlet
141 Inductive sensor

What is claimed is:

1-13. (canceled)

14: A high-pressure valve for a spray nozzle, the high-pressure valve comprising:
a valve inlet;
a valve outlet which is configured to have the spray nozzle be attachable thereto;
a fluid connection which connects the valve inlet to the valve outlet;
at least one first movable piston;
a tappet which is arranged in the fluid connection, the tappet being configured to move between a closed position and an open position via the at least one first movable piston, wherein, a spray liquid reaches at least one of the valve outlet and the spray nozzle from the valve inlet via the fluid connection when the tappet is in the open position; and
a flushing apparatus which is configured to flush at least one of the high-pressure valve and the spray nozzle with a flushing liquid.

15: The high-pressure valve as recited in claim 14, wherein the flushing apparatus comprises at least one of a flushing-liquid inlet and a flushing apparatus non-return valve.

16: The high-pressure valve as recited in claim 14, wherein the flushing apparatus is arranged at the fluid connection so that the flushing liquid emerges at the tappet perpendicular to a longitudinal orientation of the tappet.

17: The high-pressure valve as recited in claim 14, wherein the high-pressure valve is configured for a pressure in a range of from 10 MPa to 50 MPa.

18: The high-pressure valve as recited in claim 14, further comprising:
a ventilation tappet which is arranged in the fluid connection; and
a second movable piston which is configured to move the ventilation tappet.

19: The high-pressure valve as recited in claim 18, wherein at least one of the at least one first movable piston and the second movable piston are provided as a double-acting piston.

20: The high-pressure valve as recited in claim 18, further comprising:
a pressure outlet which is connected to the ventilation tappet.

21: The high-pressure valve as recited in claim 18, further comprising:
a gas inlet; and
a gas-inlet non-return valve,
wherein,
the ventilation tappet is connected to at least one of the gas inlet and to the gas inlet non-return valve.

22: The high-pressure valve as recited in claim 18, wherein the ventilation tappet is arranged in the fluid connection in a flow direction of the spray liquid behind the tappet.

23: The high-pressure valve as recited in claim 18, further comprising:
at least one inductive sensor which is configured to determine a position of at least one of the at least one first movable piston, the second movable piston, the tappet, and the ventilation tappet.

24: A method for subsequently cleaning the high-pressure valve as recited in claim 14, wherein the high pressure valve further comprises a pressure outlet which is connected to the ventilation tappet, the method comprising:
terminating an external supply of the spray liquid to the valve inlet of the high-pressure valve;
moving the tappet into the closed position via the at least one first movable piston so that the valve inlet is closed and the flushing-liquid inlet is open;
relieving a pressure on the high-pressure valve by opening the ventilation tappet via the second movable piston and dissipating the pressure via the pressure outlet;
supplying the flushing liquid through at least one of the flushing-liquid inlet and the flushing apparatus non-return valve into the fluid connection of the high-pressure valve so as to flush the pressure outlet;
closing the ventilation tappet via the second movable piston so as to close the pressure outlet; and
supplying additional flushing liquid so that at least one of the fluid connection, the tappet, the ventilation tappet, and the spray nozzle are flushed via the flushing liquid.

25: The method as recited in claim 24, wherein water having a pressure in a range of from 5 MPa to 25 MPa is used as the flushing liquid.

26: The method as recited in claim 24, wherein,
the high pressure valve further comprises:
a gas inlet; and
a gas inlet non-return valve,
wherein,
the ventilation tappet is connected to at least one of the gas inlet and to the gas inlet non-return valve, and,
after the subsequent cleaning, the method further comprises:
drying the high-pressure valve by introducing a gas at least one of through the gas inlet and via the gas inlet non-return valve.
